(19) United States
(12) Patent Application Publication
(10) Pub. No.: US 2024/0135007 A1
(43) Pub. Date: Apr. 25, 2024

(54) Memory Inline Cypher Engine with Confidentiality, Integrity, and Anti-Replay for Artificial Intelligence or Machine Learning Accelerator

(71) Applicant: MEDIATEK INC., Hsin Chu (TW)

(72) Inventors: Thomas Mengtao Zeng, San Jose, CA (US); Muhammad Umar, San Jose, CA (US); Chih-Hsiang Hsiao, Hsinchu City (TW)

(73) Assignee: MEDIATEK INC., Hsin Chu (TW)

(21) Appl. No.: 18/233,856

(22) Filed: Aug. 13, 2023

Related U.S. Application Data
(60) Provisional application No. 63/380,250, filed on Oct. 20, 2022.

(51) Int. Cl. G06F 21/60; G06F 21/62; G06F 21/79

(52) U.S. Cl. CPC G06F 21/602; G06F 21/6245; G06F 21/79

(57) ABSTRACT

A system on chip includes a secure processing unit (SPU), an artificial intelligence/machine learning accelerator (AI/ML accelerator), a memory inline cypher engine, and a central processing unit (CPU). The SPU is used to store biometrics of users. The AI/ML accelerator is used to process images, and analyze the biometrics of users. The AI/ML accelerator includes a micro control unit (MCU) for intelligently linking access identifications (IDs) to version numbers (VNs). The inline cypher engine is coupled to the AI/ML accelerator and the SPU for receiving a register file from the MCU, encrypting data received from the AI/ML accelerator, and comparing the biometrics of the users received from the SPU with the data. The CPU is coupled to the SPU and the AI/ML accelerator for controlling the SPU and the AI/ML accelerator.

### CROSS REFERENCE TO RELATED APPLICATIONS

This application claims the benefit of U.S. Provisional Application No. 63/380,250, filed on Oct. 20, 2022. The content of the application is incorporated herein by reference.

### BACKGROUND

Data encryptions including text encryption and image encryption have been an important issue due to online security in recent years. The image encryption method includes chaotic system, advanced encryption standard (AES), and artificial neural network (ANN). Among these methods, AES has been a useful block cipher for applications with e-mail encryption and Fintech. Modern block cipher is established on iterative operations to generate cipher texts. The iterative cipher texts apply different child-keys which are generated from an original key in each iteration. AES includes an add round key step, sub bytes step, shift rows step, and mix column step.

In a prior art encryption, an integrity tree is applied to combine off-chip version numbers (VNs) and physical addresses (PAs) of an off-chip dynamic random access memory (DRAM) to generate a counter. The root of the integrity tree is on-chip while the leaves of the integrity tree are off-chip. The data from an artificial intelligence/machine learning accelerator (AI/ML accelerator) is encrypted by the counter.

The AI/ML accelerator is gaining popularity due to the prosperity in artificial intelligence (AI) research and development. Common Deep neural network (DNN) and convolutional neural network (CNN) such as ResNet can be accelerated by the AI/ML accelerator instead of expensive graphic processing unit (GPU) to reduce cost and power consumption in AI applications. Therefore, the security issue is important to implement AI applications such as facial recognition.

However, off-chip encryption needs interface between a system on chip (SOC) and DRAM, thus off-chip encryption lacks of high security. In addition, the cost of off-chip encryption is higher than on-chip encryption. A secure and lower power solution is needed.

### SUMMARY

An embodiment discloses a system on chip. The system on chip comprises a secure processing unit (SPU), an artificial intelligence/machine learning accelerator (AI/ML accelerator), a memory inline cypher engine for confidentiality, integrity, and anti-replay, an input-output memory management unit (IOMMU), a micro processing unit (MPU) and a central processing unit (CPU). The SPU is used to store biometrics of users. The AI/ML accelerator is used to process images, and analyze the biometrics of users. The AI/ML accelerator comprises a micro control unit (MCU) for intelligently linking access identifications (IDs) to version numbers (VNs). The inline cypher engine is coupled to the AI/ML accelerator and the SPU for receiving a register file from the MCU, encrypting data received from the AI/ML accelerator, and comparing the biometrics of the users received from the SPU with the data. The IOMMU is coupled to the inline cypher engine for accessing the inline cypher engine. The MPU is coupled to the IOMMU for controlling a dynamic random access memory (DRAM) and controlling the IOMMU to access the inline cypher engine. The CPU is coupled to the SPU and the AI/ML accelerator for controlling the SPU and the AI/ML accelerator.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows an encryption architecture according to an embodiment of the present disclosure.

FIG. 2 shows an encryption architecture according to another embodiment of the present disclosure.

FIG. 3 shows a system on chip (SOC) with a DRAM according to an embodiment of the present disclosure.

FIG. 4 shows the access of the secure AI/ML accelerator memory in the machine learning model according to an embodiment of the present disclosure.

FIG. 5 shows the multi-layer encryption method according to an embodiment of the present disclosure.

FIG. 6 is a flowchart of an encryption method of the encryption architecture in FIG. 2.

FIG. 7 shows a system on chip (SOC) with a DRAM according to another embodiment of the present disclosure.

### DETAILED DESCRIPTION

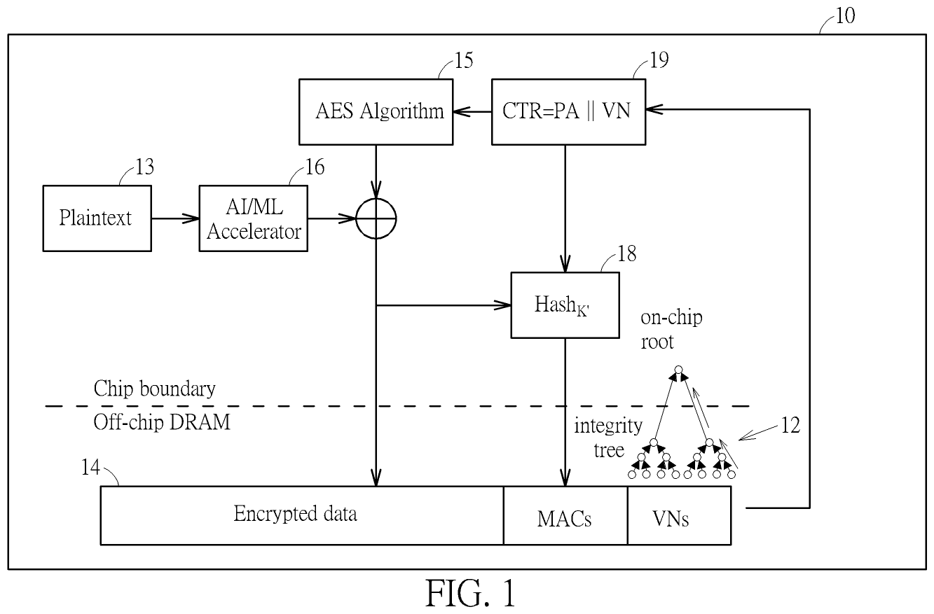

The present disclosure is related to a system on chip (SOC). FIG. 1 shows an encryption architecture 10 according to an embodiment of the present disclosure. An integrity tree 12 is applied to combine version numbers (VNs) and physical addresses (PAs) of an off-chip dynamic random access memory (DRAM) 14 by OR operations to generate a counter 19. The root of the integrity tree 12 is on-chip while the leaves of the integrity tree are off-chip. The version numbers are the leaves of the integrity tree and are stored in the off-chip DRAM 14. The data generated by an artificial intelligence/machine learning accelerator (AI/ML accelerator) 16 from plaintext 13 is encrypted by an advanced encryption standard (AES) algorithm 15 with the counter 19 to generate encrypted data. The encrypted data and the counter are then forwarded to a hash table 18 to generate Message Authentication Codes (MACs). The encrypted data and the MACs are both stored in the off-chip DRAM 14.

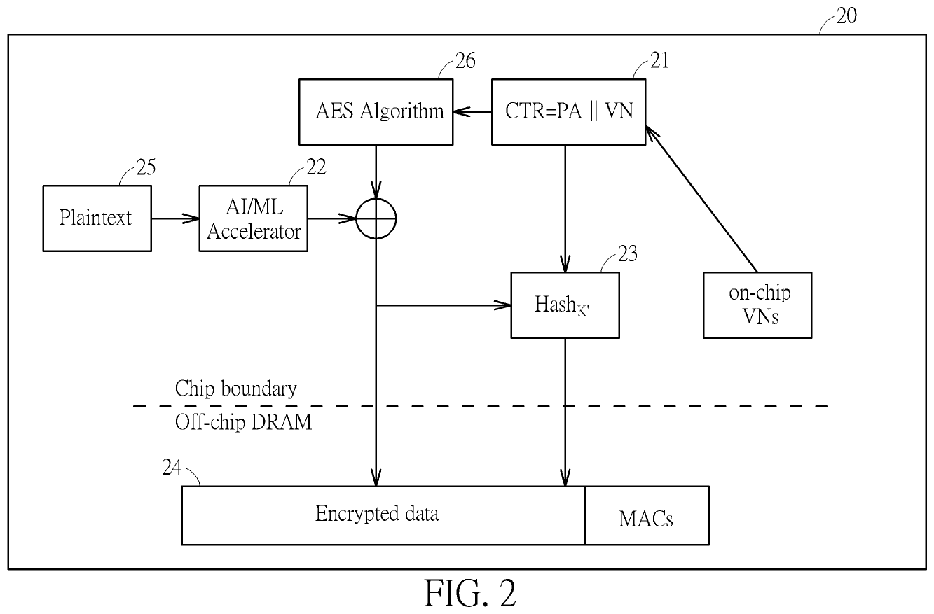

FIG. 2 shows an encryption architecture 20 according to another embodiment of the present disclosure. In FIG. 2, the on-chip version numbers are combined with physical addresses of an off-chip DRAM 24 by OR operations to generate a counter 21. The data generated by an artificial intelligence/machine learning accelerator 22 from plaintext 25 is encrypted by an AES algorithm 26 with the counter 21 to generate encrypted data. The encrypted data and the counter 21 are then forwarded to a hash table 23 to generate Message Authentication Codes (MACs). The encrypted data and the MACs are both stored in the off-chip DRAM 24. Compared with the encryption architecture 10, the encryption architecture 20 has no need for the integrity tree 12 because the encryption architecture 20 requires less VNs, and thus the VNs can be stored on-chip, enhancing security. The AES algorithm. 26 and the hash table 23 are implemented in a memory inline cypher engine for confidentiality, integrity, and anti-replay. The confidentiality of the inline cypher engine comes from the AES algorithm using the counter 21. The integrity of the inline cypher engine is verified using per-block message authentication codes (MACs). The anti-replay of the inline cypher engine comes from the on-chip VNs.

The encryption architecture 10 can be applied to applications with an unpredictable memory access pattern using fine-grained VNs saved in an integrity tree while the encryption architecture 20 is applied to applications with a predictable memory access pattern using coarse-grained VNs saved in an array. The coarse-grained VNs are stored on a large on-chip data buffer instead of the off-chip DRAM 14 since the coarse-grained VNs are expected to be limited in number.

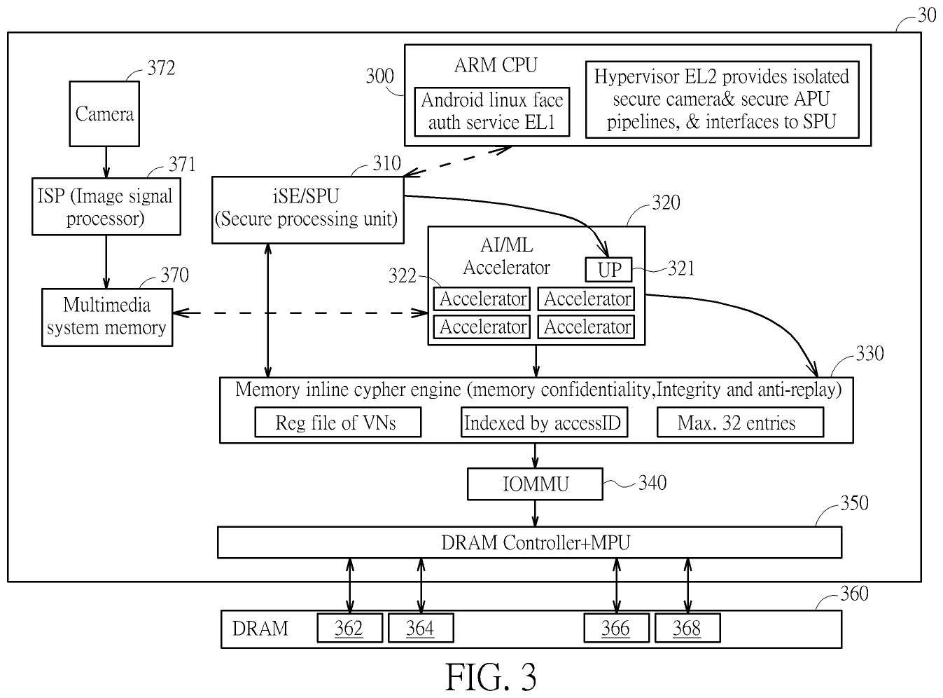

FIG. 3 shows a system on chip (SOC) 30 with a DRAM 360 according to an embodiment of the present disclosure. The SOC 30 may comprise a secure processing unit (SPU) 310, an artificial intelligence/machine learning accelerator (AI/ML accelerator) 320, a inline cypher engine 330, an input-output memory management unit (IOMMU) 340, a micro processing unit (MPU) 350, a multimedia system memory 370 and a central processing unit (CPU) 300. The secure processing unit (SPU) 310 is configured to store information such as biometrics of users. The biometrics of the users may contain a face model description. The artificial intelligence/machine learning accelerator (AI/ML accelerator) 320 is configured to process images, and analyze the biometrics of the users. The AI/ML accelerator 320 comprises a micro control unit (MCU) 321 configured to intelligently link access identifications (IDs) to on-chip version numbers (VNs). The inline cypher engine 330 is coupled to the AI/ML accelerator 320 and the SPU 310, and configured to receive a register file from the MCU 321, encrypt data received from the AI/ML accelerator 320, and compare the biometrics of the users received from the SPU 310 with the data. The IOMMU 340 is coupled to the inline cypher engine 330 and configured to access the inline cypher engine 330. The MPU 350 is coupled to the IOMMU 340 and configured to control the DRAM 360 and control the IOMMU 340 to access the inline cypher engine 330. The CPU 300 is coupled to the SPU 310 and the AI/ML accelerator 320, and configured to control the SPU 310 and the AI/ML accelerator 320. The multimedia system memory 370 is coupled to the AI/ML accelerator 320 and configured to save the images and transmit the images to the AI/ML accelerator 320.

The multimedia system memory 370 is further coupled to an image signal processor (ISP) 371 for receiving image data from the ISP 371. The ISP 371 is coupled to a camera 372 for receiving raw data from the camera 372. The CPU 300 provides pipelines for the camera 372 and the AI/ML accelerator 320, and provides interfaces to the SPU 310.

The AI/ML accelerator 320 may contain deep neural network (DNN) accelerators with a plurality of layers encrypted simultaneously by the inline cypher engine 330. The AI/ML accelerator 320 is coupled to the SPU 310 and further configured to receive commands from the SPU 310 for controlling the DNN accelerators. In another embodiment, the AI/ML accelerator 320 may contain convolutional neural network (CNN) accelerators with a plurality of layers encrypted simultaneously by the inline cypher engine 330. The AI/ML accelerator 320 is coupled to the SPU 310 and further configured to receive commands from the SPU 310 for controlling the CNN accelerators.

The inline cypher engine 330 may encrypt the data from the AI/ML accelerator 320 indexed by the access IDs from the MCU 321 using random permutation among channels and/or layers of outputs of the AI/ML accelerator. The inline cypher engine 330 may decrypt data from the IOMMU 340 indexed by the access IDs from the MCU 321 using random permutation among channels and/or layers of outputs of the AI/ML accelerator 320.

The DRAM 360 comprises an SPU firmware memory 362 configured to save firmware codes of the SPU 310, an SPU MACs memory 364 configured to save SPU memory MACs, a secure AI/ML accelerator memory 366 configured to save model parameters and intermediate feature maps of the AI/ML accelerator 320, and a secure AI/ML accelerator MACs memory 368 configured to save AI/ML accelerator memory MACs protected by the MPU 350.

In one iteration, the raw data captured by the camera 372 is fed into the ISP 371 and the image data preprocessed by the ISP 371 is sent to the multimedia system memory 370. Then, the AI/ML accelerator 320 obtains the image data from multimedia system memory 370 and analyzes the image data through machine learning model with pre-trained parameters, weightings and biases in accelerators 322 to generate a plurality of output layers. The data from the output layers are sent to the inline cypher engine 330 and encrypted with AES algorithm before being saved in the DRAM 360. The encryption is performed across different output layers and is on-chip, so it is highly secured and hard to be cracked due to the property of machine learning models such as convolutional neural network (CNN) and deep neural network (DNN).

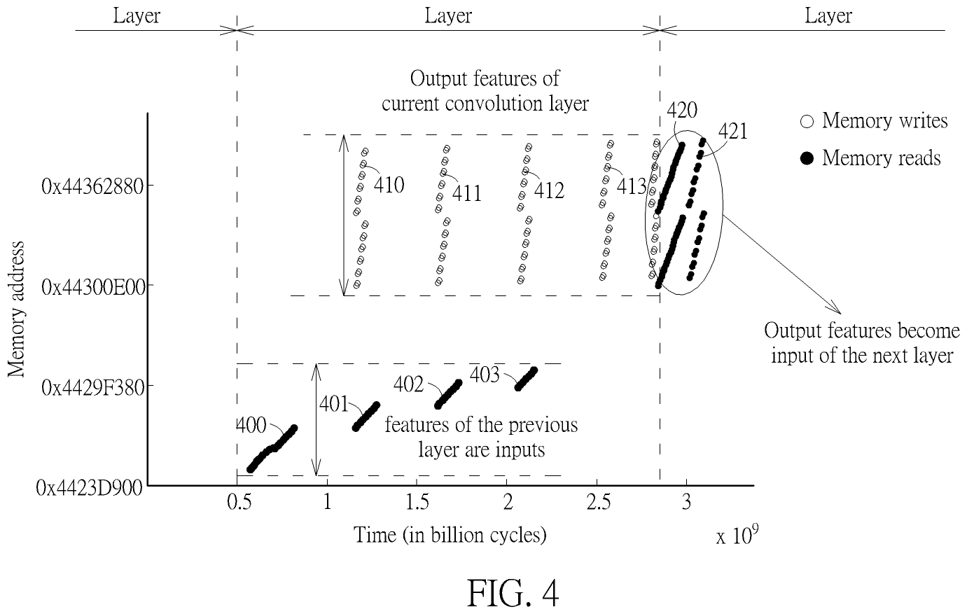

FIG. 4 shows the access of the secure AI/ML accelerator memory 366 in the machine learning model according to an embodiment of the present disclosure. The image data is sent into the AI/ML accelerator 320 for analysis. The input data from the secure AI/ML accelerator memory 366 is segmented into a plurality of data segments 400, 401, 402, and 403. The machine learning model has first layer outputs 410, 411, 412, and 413 generated from the data segments 400, 401, 402, and 403, respectively. The first layer outputs 410, 411, 412, and 413 in the machine learning model are second layer inputs 420, 421 in the machine learning model. The first layer outputs 410, 411, 412 are written when the data segments 401, 402, 403 are read, respectively. Therefore, accessing the data from the secure AI/ML accelerator memory 366, and writing data into the secure AI/ML accelerator memory 366 in the machine learning model can be performed simultaneously. In addition, the encryption of data output by the machine learning model can also be performed at the same time.

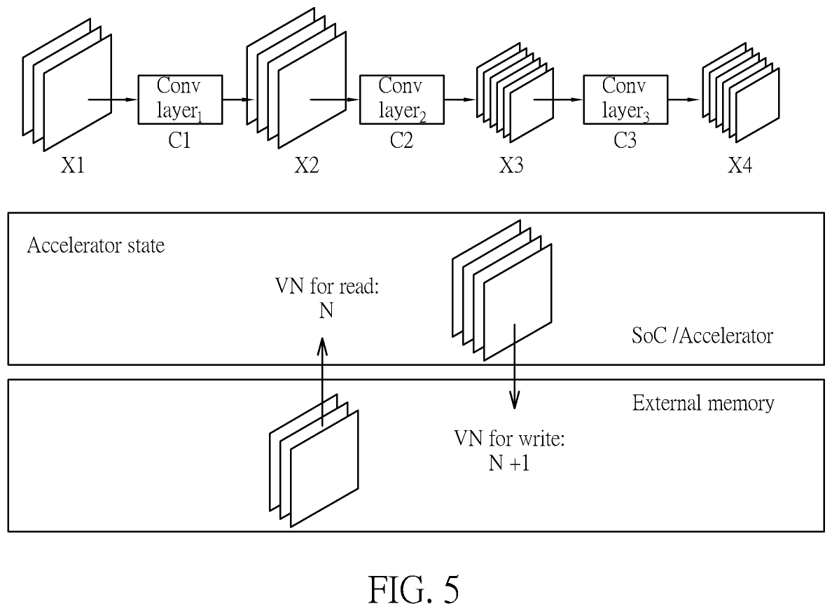

FIG. 5 shows the multi-layer encryption method according to an embodiment of the present disclosure. The image data from the multimedia system memory 370 is inputted to the AI/ML accelerator 320 as a first layer X1 and is fed into a first convolution layer C1 to generate a second layer X2. The second layer X2 is fed into a second convolution layer C2 to generate a third layer X3. The third layer X3 is fed into a third convolution layer C3 to generate a fourth layer X4, and so on. If a layer in the machine learning model to be read has a version number N, then a layer in the machine learning model to be written would have a version number N+1. For instance, if the first layer X1 has a version number 1, then the second layer X2 would have a version number 2, the third layer X3 would have a version number 3, and the fourth layer X4 would have a version number 4. When performing the read and write of data in different layers of the machine learning model, encryption can be performed among different layers at the same time. Thus, the permutation of different channels and different layers are randomly scrambled instead of only encrypting the image data such as RGB data to enhance security on chip due to the complexity of various layers in the machine learning model.

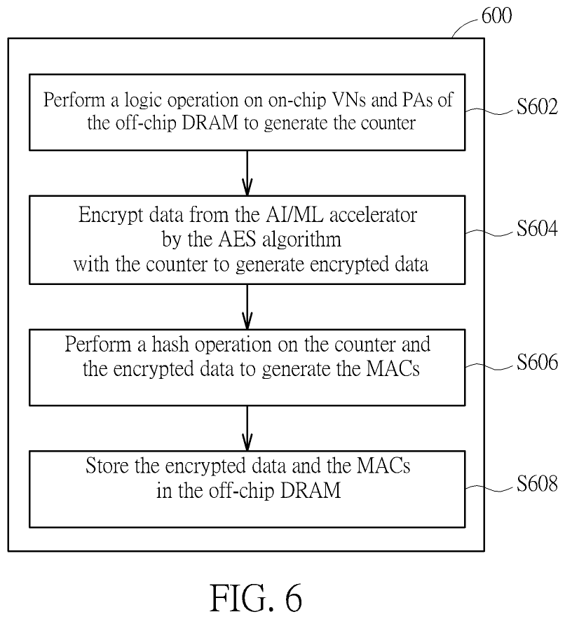

FIG. 6 is a flowchart of an encryption method 600 of the encryption architecture 20. The encryption method 600 comprises the following steps:

Step S602: perform a logic operation on on-chip VNs and PAs of the off-chip DRAM 24 to generate the counter 21;

Step S604: encrypt data from the AI/ML accelerator 22 by the AES algorithm 26 with the counter 21 to generate encrypted data;

Step S606: perform a hash operation 23 on the counter 21 and the encrypted data to generate the MACs; and

Step S608: store the encrypted data and the MACs in the off-chip DRAM 24.

In Step S602, the logic operation may be an OR operation. In Step S604, the data from the AI/ML accelerator 22 may be data output from layers of a deep neural network (DNN) or a convolutional neural network (CNN). In Step S606, the MACs may include SPU memory MACs and AI/ML accelerator memory MACs.

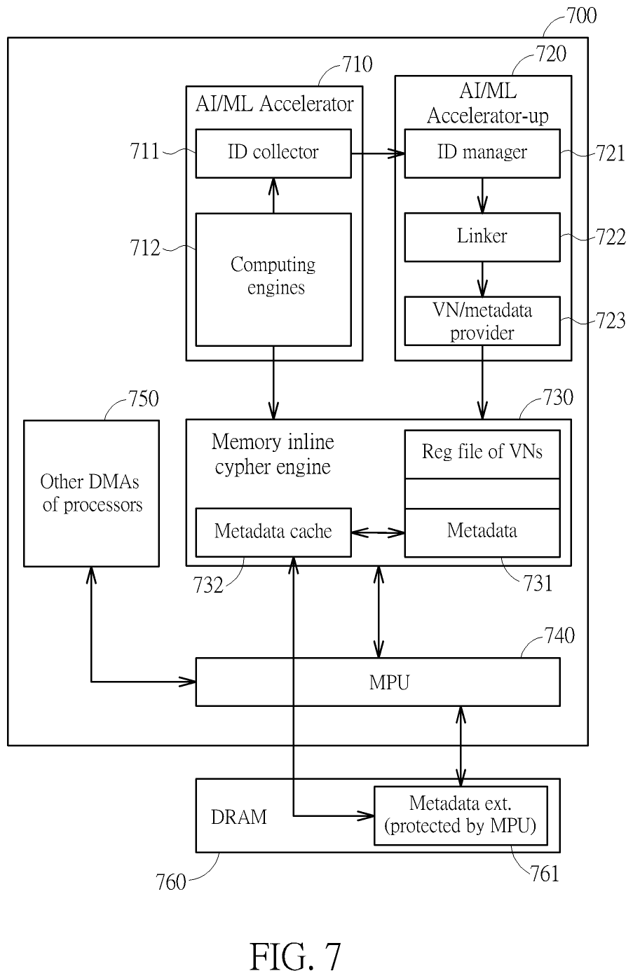

FIG. 7 shows a system on chip 700 comprising an AI/ML accelerator 710, an MCU 720, a inline cypher engine 730, and an MPU 740 with an off-chip DRAM 760 according to an embodiment of the present disclosure. The AI/ML accelerator 710 comprises an ID collector 711 and computing engines 712. The ID collector 711 collects access IDs from the computing engines 712. The MCU 720 comprises an ID manager 721, a linker 722, and a VN/metadata provider 723. The ID manager 721 receives the access IDs from ID collector 711, and the linker 722 links the access IDs to corresponding VNs. The VN/metadata provider 723 receives the VNs from the linker 722 and provides metadata and the VNs to the inline cypher engine 730. The inline cypher engine 730 comprises a memory 731 and a metadata cache 732. The inline cypher engine 730 encrypts data received from the AI/ML accelerator 710. The memory 731 has the metadata stored therein, and is coupled to the VN/metadata provider 723 and configured to receive a register file of the VNs from the VN/metadata provider 723. The metadata cache 732 is coupled to the memory 731, and configured to access the metadata. The MPU 740 is coupled to the inline cypher engine 730 and configured to control the DRAM 760 and access the inline cypher engine 730. The DRAM 760 is coupled to the MPU 740 and comprises a memory space 761 configured to store external metadata protected by the MPU 740. The system on chip 700 may further comprise other DMAs or processors 750 coupled to the MPU 740.

In the SOC 30, 700, the inline cypher engine encrypts the data from the AI/ML accelerator using advanced encryption standard (AES) among channels and/or layers of outputs of the AI/ML accelerator, and all the VNs are on-chip. Therefore, the security is enhanced due to multi-layer multi-channel encryption, and on-chip solution.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system on chip comprising:
a secure processing unit (SPU) configured to store information;
an artificial intelligence or machine learning accelerator (AI/ML accelerator) configured to process images, and analyze the information, the AI/ML accelerator comprising a micro control unit (MCU) configured to link access identifications (IDs) to version numbers (VNs); and
a memory inline cypher engine coupled to the AI/ML accelerator and the SPU, and configured to receive a register file from the MCU, encrypt data received from the AI/ML accelerator, and compare the information received from the SPU with the data.

2. The system on chip of claim 1, further comprising an input-output memory management unit (IOMMU) coupled to the inline cypher engine and configured to access the inline cypher engine.

3. The system on chip of claim 2, wherein the inline cypher engine decrypts data from the IOMMU indexed by the access IDs from the MCU.

4. The system on chip of claim 2, wherein the inline cypher engine decrypts data from the IOMMU using random permutation among channels and/or layers of outputs of the AI/ML accelerator.

5. The system on chip of claim 2, further comprising a micro processing unit (MPU) coupled to the IOMMU and configured to control a dynamic random access memory (DRAM) and control the IOMMU to access the inline cypher engine.

6. The system on chip of claim 5, wherein the DRAM comprises:
a first memory space configured to save firmware codes of the SPU;
a second memory space configured to save SPU memory message authentication codes (MACs);
a third memory space configured to save model parameters and intermediate feature maps of the AI/ML accelerator; and
a fourth memory space configured to save AI/ML accelerator memory message authentication codes (MACs) protected by the MPU.

7. The system on chip of claim 1, further comprising a central processing unit (CPU) coupled to the SPU and the AI/ML accelerator, and configured to control the SPU and the AI/ML accelerator.

8. The system on chip of claim 7, further comprising a multimedia system memory coupled to the AI/ML accelerator and configured to save the images and transmit the images to the AI/ML accelerator.

9. The system on chip of claim 8, wherein the multimedia system memory is coupled to an image signal processor (ISP) for receiving image data from the ISP.

10. The system on chip of claim 9, wherein the ISP is coupled to a camera for receiving raw data from the camera.

11. The system on chip of claim 10, wherein the CPU provides pipelines for the camera and the AI/ML accelerator, and provides interfaces to the SPU.

12. The system on chip of claim 1, wherein the information contains a face model description.

13. The system on chip of claim 1, wherein the AI/ML accelerator contains deep neural network (DNN) accelerators with a plurality of layers encrypted simultaneously by the inline cypher engine, and the AI/ML accelerator is coupled to the SPU and further configured to receive commands from the SPU for controlling the DNN accelerators.

14. The system on chip of claim 1, wherein the AI/ML accelerator contains convolutional neural network (CNN) accelerators with a plurality of layers encrypted simultaneously by the inline cypher engine, and the AI/ML accelerator is coupled to the SPU and further configured to receive commands from the SPU for controlling the CNN accelerators.

15. The system on chip of claim 1, wherein the inline cypher engine encrypts the data from the AI/ML accelerator indexed by the access IDs from the MCU.

16. The system on chip of claim 1, wherein the VNs are stored on-chip.

17. The system on chip of claim 1, wherein the inline cypher engine encrypts the data from the AI/ML accelerator using random permutation among channels and/or layers of outputs of the AI/ML accelerator.

18. A system on chip comprising:
an artificial intelligence/machine learning accelerator (AI/ML accelerator) configured to process images, the AI/ML accelerator comprising:
an Identification (ID) collector; and
computing engines coupled to the ID collector and configured to send access IDs to the ID collector;
a micro control unit (MCU) configured to link the access IDs to version numbers (VNs), the MCU comprising:
an ID manager coupled to the ID collector and configured to receive the access IDs from the ID collector;
a linker coupled to the ID manager and configured to link the VNs with the access IDs; and
a VN/metadata provider coupled to the linker, and configured to receive the VNs from the linker and provide metadata and the VNs;
a memory inline cypher engine coupled to the AI/ML accelerator and the MCU and configured to encrypt data received from the AI/ML accelerator, the inline cypher engine comprising:
a memory having the metadata stored therein, coupled to the VN/metadata provider and configured to receive a register file of the VNs from the VN/metadata provider; and
a metadata cache coupled to the memory, and configured to access the metadata; and
a micro processing unit (MPU) coupled to the inline cypher engine and configured to control a dynamic random access memory (DRAM) and access the inline cypher engine.

19. The system on chip of claim 18, wherein the DRAM is coupled to the MPU and comprises a memory space configured to store external metadata protected by the MPU.
